(19) United States
(12) Patent Application Publication
(10) Pub. No.: US 2012/0201578 A1
(43) Pub. Date: Aug. 9, 2012

(54) INTERMEDIATE TRANSFER BELT, IMAGE FORMING APPARATUS, AND METHOD FOR PRODUCING INTERMEDIATE TRANSFER BELT

(75) Inventors: Kenichi MASHIKO, Kanagawa (JP); Jun Aoto, Kanagawa (JP); Hidetaka Kubo, Kanagawa (JP); Sayaka Katoh, Kanagawa (JP); Shinichi Nitta, Miyagi (JP)

(73) Assignee: RICOH COMPANY, LTD, Tokyo (JP)

(21) Appl. No.: 13/364,655

(22) Filed: Feb. 2, 2012

(30) Foreign Application Priority Data
Feb. 8, 2011 (JP) 2011-024938

(51) Int. Cl. G03G 15/20

(52) U.S. Cl. 399/308

(57) ABSTRACT

An intermediate transfer belt configured to receive a toner image formed by developing, with a toner, a latent image on an image bearing member, the intermediate transfer belt including a base layer and an elastic layer laid on the base layer, wherein the elastic layer includes spherical resin particles and a layer formed of an elastic body, and has a concavo-convex pattern in a surface of the elastic layer, wherein the spherical resin particles are arranged in a plane direction in the surface of the elastic layer, and wherein the intermediate transfer belt has glossiness of 35% or higher as determined based on reflected light at 85° on the surface of the intermediate transfer belt.

### BACKGROUND OF THE INVENTION

1. Field of the Invention

The present invention relates to an intermediate transfer belt, such as a seamless belt, to be installed in an image forming apparatus such as a copier or a printer, an image forming apparatus using the intermediate transfer belt, and a method for producing the intermediate transfer belt, and relates particularly to an intermediate transfer belt suitable for full-color image formation.

2. Description of the Related Art Conventionally, for a variety of purposes, seamless belts have been used as members incorporated in electrophotographic apparatuses. In a present-day full-color electrophotographic apparatus, in particular, the method using an intermediate transfer belt is employed, wherein developed images of four colors, i.e., yellow, magenta, cyan and black, are temporarily superimposed onto one another over an intermediate transfer medium and then transferred onto a transfer medium (such as paper) at one time. In the method described above, a seamless belt is employed as the intermediate transfer belt.

The foregoing method using an intermediate transfer belt, conventionally used in a system in which developing devices for four colors are used with one photoconductor, is disadvantageous in that the printing speed is low. Accordingly, for high-speed printing, the four-drum tandem method is often used, wherein photoconductors for four colors (four photoconductors) are aligned and images of each color are continuously transferred to paper. However, in the four-drum tandem method, for example due to variation of paper that arises depending upon the environment, it is very difficult to secure positional accuracy for superimposition of images of each color, and consequently images with displaced colors are often formed. Accordingly, employment of the intermediate transfer method in the four-drum tandem method has been becoming popular.

Under these circumstances, demands for properties (such as high-speed transfer and positional accuracy) of the intermediate transfer belt are heightening and it is becoming necessary to satisfy these demanded properties. For positional accuracy, in particular, reduction in variation caused by deformation (e.g., expansion) of the belt itself, which results from continuous use, is demanded. Also, since the intermediate transfer belt is laid out over a wide area in an apparatus and high voltage is applied thereto for image transfer, the intermediate transfer belt is required to be flame-retardant. To meet such demands, polyimide resins, polyamide-imide resins and the like, which are highly elastic, highly heat-resistant resins, are primarily used as materials for intermediate transfer belts.

It should, however, be noted that an intermediate transfer belt formed of a polyimide resin has high strength and thus high surface hardness; thus, high pressure is applied to a toner layer when a toner image is transferred, and there is local aggregation of toner, thereby possibly forming a partially non-transferred image where part of the image is not transferred. Moreover, the intermediate transfer belt is inferior in terms of its conformity to a photoconductor and to a paper that the intermediate transfer belt touches at a transfer section; consequently, in some cases, portions of faulty contact (empty spaces) are created at the transfer section and thus transfer unevenness may arise.

Nowadays, images are frequently formed on a variety of types of paper, using full-color electrophotography, and there are increasing occasions where types of paper varying from slippery, highly smooth paper, such as coated paper, to paper with rough surfaces, such as recycled paper, embossed paper, Japanese paper and kraft paper, are used. Conformity to such paper with different surface conditions is important; poor conformity could cause paper to have color tone unevenness and shade unevenness in a concavo-convex form.

To solve the foregoing problems, a variety of intermediate transfer belts wherein a relatively flexible layer is laid over a base layer have been proposed.

In the case where a relatively flexible layer is used as a surface layer of an intermediate transfer belt, transfer pressure can be reduced and conformity to protrusions and depressions of a paper surface can be improved; however, there is a problem in that since the surface layer is inferior in releasability, toner cannot be favorably released from the surface layer, which causes a decrease in transfer efficiency, and the above favorable effects cannot be fully taken advantage of. Moreover, there is another problem in that the surface layer is inferior in abrasion resistance and scratch resistance as well.

To solve these problems, there is a method of providing a protective layer in addition to the above-mentioned layers; however, this method is unfavorable because if a material with sufficiently high transfer performance is coated with the protective layer, it is difficult for the protective layer to conform to the flexibility of a flexible layer, and thus cracks and peeling are easily caused.

Thus, in order to protect the flexible surface layer without causing the foregoing problems, improvement in transferability by attachment of fine particles to a surface has been proposed.

Japanese Patent Application Laid-Open (JP-A) No. 09-230717 proposes covering an intermediate transfer member with beads which are 3 μm or less each in diameter. However, the covering method described in JP-A No. 09-230717 is not sufficient in terms of durability required for present-day electrophotographic apparatuses because detachment of particles (beads) arises.

JP-A Nos. 2002-162767 and 2004-354716 propose formation of a layer with the use of a material which has an affinity for hydrophobized fine particles. In these laid-open patent applications, particles having very small diameters are preferably used. However, a thick particle layer is formed, ununiform portions are created by aggregation of particles and there is variation in transfer performance; consequently, it is difficult to obtain an intermediate transfer belt which can help satisfy the high-level image quality that present-day electrophotographic apparatuses are required to yield.

JP-A Nos. 2007-328165 and 2009-75154 propose realizing durability by burying relatively large particles in a resin to some extent. However, in these proposals as well, the particles are present ununiformly, and thus it is difficult to obtain an intermediate transfer belt which can help satisfy the high-level image quality that the present-day electrophotographic apparatuses are required to yield.

Silica is preferably used in all of the above-mentioned techniques disclosed in JP-A Nos. 09-230717, 2002-162767, 2004-354716, 2007-328165 and 2009-75154; note that since silica particles have strong cohesive force, it is difficult to form a uniform particle layer. Particularly, an ununiform particle layer with varying outermost surface height results in cleaning failures and filming of fine toner particles.

Moreover, inorganic particles such as silica particles scratch the surface of an organic photoconductor suitably used as a latent image bearing member in charge of image formation, and cause the surface to be easily abraded and to decrease in durability, as the inorganic particles come into contact with the organic photoconductor at a transfer section.

### SUMMARY OF THE INVENTION

The present invention has been made in light of the above-mentioned techniques in the prior art and aims to provide an intermediate transfer belt which is flexible, superior in toner releasability, capable of realizing a high transfer rate regardless of the type of a transfer medium, superior in residual toner cleaning property and filming resistance, and capable of being used to realize an electrophotographic apparatus which has high durability and can form high-quality images over a long period of time.

The present invention also aims to provide a method for producing an electrophotographic apparatus which has high durability and can form high-quality images over a long period of time and in which the intermediate transfer belt is installed.

The “electrophotographic apparatus” hereinafter may be referred to as an “image forming apparatus.”

As a result of carrying out earnest examinations, the present inventors have found that the above-mentioned problems can be solved by an intermediate transfer belt configured to receive a toner image formed by developing, with a toner, a latent image on an image bearing member, wherein the intermediate transfer belt includes a base layer and an elastic layer laid on the base layer; wherein the elastic layer includes an layer formed of an elastic body and spherical resin particles, and have a concavo-convex pattern in a surface of the elastic layer, wherein the spherical resin particles are arranged in a plane direction in the surface of the elastic layer, and wherein the intermediate transfer belt has glossiness of 35% or higher as determined based on reflected light at 85° on the surface of the intermediate transfer belt.

The present invention is based on the above finding obtained by the present inventors. Means for solving the above problems are as follows.

An intermediate transfer belt configured to receive a toner image formed by developing, with a toner, a latent image on an image bearing member, the intermediate transfer belt including: a base layer; and

an elastic layer laid on the base layer;

wherein the elastic layer includes spherical resin particles and a layer formed of an elastic body, and has a concavo-convex pattern in a surface of the elastic layer,

wherein the spherical resin particles are arranged in a plane direction in the surface of the elastic layer, and

wherein the intermediate transfer belt has glossiness of 35% or higher as determined based on reflected light at 85° on the surface of the intermediate transfer belt.

The present invention can provide an intermediate transfer belt which is flexible, superior in toner releasability, capable of realizing a high transfer rate regardless of the type of a transfer medium, superior in residual toner cleaning property and filming resistance, and capable of being used to realize an electrophotographic apparatus which has high durability and can form high-quality images over a long period of time.

### BRIEF DESCRIPTION OF THE DRAWINGS

FIG. 1 is a schematic drawing showing an example of a layer structure of an intermediate transfer belt according to the present invention.

FIG. 2 is a schematic drawing showing a cross-sectional form of an elastic layer of an intermediate transfer belt according to the present invention.

FIG. 3 is a schematic drawing showing a cross-sectional form of an intermediate transfer belt in which exposed portions of spherical resin particles from an elastic layer have varying heights.

FIG. 4 is a schematic drawing showing a cross-sectional form of an intermediate transfer belt for explaining one exemplary hₘₐₓ and hₘᵢₙ.

FIG. 5 is a schematic drawing showing a cross section of an intermediate transfer belt including an elastic layer which contains spherical resin particles in a plurality of layers.

FIG. 6 is a schematic drawing showing a device for coating a base layer and an elastic layer according to the present invention.

FIG. 7 is a schematic drawing showing a device for applying and fixing spherical resin particles (powder particles) used in the present invention.

FIG. 8 is a main-part schematic drawing for explaining an image forming apparatus which includes an intermediate transfer belt according to the present invention.

FIG. 9 is a main-part schematic drawing showing a structural example of an image forming apparatus wherein a plurality of photoconductor drums are aligned along one intermediate transfer belt according to the present invention.

### DETAILED DESCRIPTION OF THE INVENTION

### (Intermediate Transfer Belt)

An intermediate transfer belt according to the present invention is an intermediate transfer belt configured to receive a toner image formed by developing, with a toner, a latent image on an image bearing member, the intermediate transfer belt including: a base layer; and an elastic layer laid on the base layer, wherein the elastic layer includes an layer formed of an elastic body and spherical resin particles, and have a concavo-convex pattern in a surface of the elastic layer, wherein the spherical resin particles are arranged in a plane direction in the surface of the elastic layer, and wherein the intermediate transfer belt has glossiness of 35% or higher as determined based on reflected light at 85° on the surface of the intermediate transfer belt.

The following explains the intermediate transfer belt according to the present invention in detail.

The embodiment described below is a preferred embodiment of the present invention, and though various technically preferred limitations are given, in the following description, it should not be construed that the scope of the present invention is limited to this embodiment unless otherwise specifically indicating that the present invention is limited thereto.

An electrophotographic apparatus uses seamless belts as several members. One of the important members required for electrical characteristics is an intermediate transfer member (intermediate transfer belt). The following explains the intermediate transfer belt according to the present invention.

An intermediate transfer belt according to the present invention is a seamless belt suitably installed in an image forming apparatus employing an intermediate transfer belt system, in which a plurality of developed color toner images are sequentially formed on an image bearing member (e.g., a photoconductor drum) and then sequentially superposed on top of each other on an intermediate transfer belt to perform primary transfer, and the resultant primarily transferred image is secondarily transferred onto a recording medium (hereinafter may be referred to as a “transfer medium”) at one time.

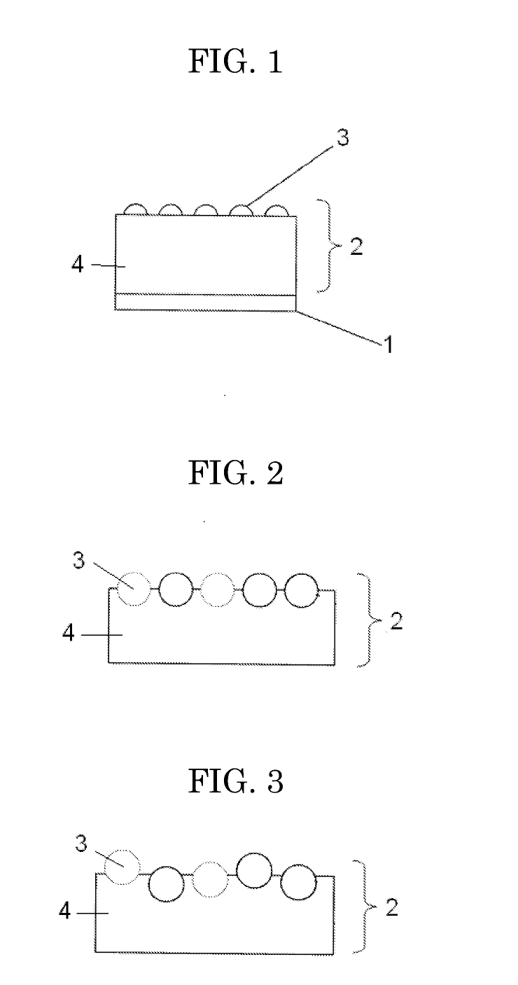

FIG. 1 shows a layer structure of an intermediate transfer belt suitably used in the present invention. Note that the layer structure of the intermediate transfer belt of the present invention is not limited to this layer structure.

Regarding the foregoing structure, a flexible elastic layer 2 is laid over a relatively-bendable rigid base layer 1. The elastic layer 2 includes a layer formed of an elastic body 4 and spherical resin particles 3. The spherical resin particles 3 are arranged in a plane direction in the surface of the elastic layer 2. In other words, the spherical resin particles 3 are exposed from the surface of the layer formed of an elastic body 4.

The intermediate transfer belt has glossiness of 35% or higher as determined based on reflected light at 85° on the surface of the intermediate transfer belt. The intermediate transfer belt has preferably glossiness from 45.0% to 60.0% as determined based on reflected light at 85° on the surface of the intermediate transfer belt.

The intermediate transfer belt has also preferably glossiness of 5% or lower, more preferably from 0.5% to 3.0% as determined based on reflected light at 60° on the surface of the intermediate transfer belt. The glossiness can be measured using a glossmeter.

### <Base Layer>

First of all, the base layer is described.

As a constituent material for the base layer, a resin which contains a filler (or an additive) for adjusting electrical resistance, otherwise referred to as “electrical resistance adjuster”, can be used, for example.

It is preferred in terms of flame retardance that the resin be a fluorine resin such as PVDF (PolyVinylidene DiFluoride) or ETFE (Ethylene-tetrafluoroethylene copolymer), a polyimide resin, a polyamide-imide resin, etc.; it is particularly preferred in terms of mechanical strength (elasticity) and heat resistance that the resin be a polyimide resin or a polyamide-imide resin.

Examples of the electrical resistance adjuster include a metal oxide, carbon black, an ionic conductive agent and a conductive polymer material.

Examples of the metal oxide include zinc oxide, tin oxide, titanium oxide, zirconium oxide, aluminum oxide and silicon oxide. Also, the metal oxide may be surface-treated beforehand to enhance dispersibility.

Examples of the carbon black include ketjen black, furnace black, acetylene black, thermal black and gas black.

Examples of the ionic conductive agent include tetraalkylammonium salts, trialkylbenzylammonium salts, alkylsulfonate salts, alkylbenzenesulfonates, alkylsulfates, glycerin fatty acid esters, sorbitan fatty acid esters, polyoxyethylene alkylamines, polyoxyethylene fatty acid alcohol esters, alkylbetaines and lithium perchlorate. These may be used in combination.

Note that the electrical resistance adjuster in the present invention is not limited to the above-mentioned compounds mentioned as examples.

Also, in producing the intermediate transfer belt of the present invention, contains a resin component as a coating liquid for forming the base layer, and may if necessary contain additives such as a dispersion auxiliary agent, a reinforcing material, a lubricant, a heat-conducting material and an antioxidant.

The amount of the electrical resistance adjuster contained in a seamless belt suitably installed as the intermediate transfer belt is preferably adjusted such that the surface resistance value is kept in the range of 1×10⁸ Ω/sq. to 1×10¹³ Ω/sq. and the volume resistance value is kept in the range of 1×10⁶ Ω·cm to 1×10¹² Ω·cm; in view of mechanical strength, the electrical resistance adjuster should be added in a selected amount that does not allow the formed layer to become brittle and breakable.

That is, in producing the intermediate transfer belt, it is preferable to produce a seamless belt having a favorable balance between electrical properties (surface resistance and volume resistance) and mechanical strength, using a coating liquid prepared by mixing the resin (e.g., a polyimide resin precursor or a polyamide-imide resin precursor) and the electrical resistance adjuster in an appropriately adjusted manner.

In the case where the electrical resistance adjuster is carbon black, the amount of the electrical resistance adjuster occupies preferably 10% by mass to 25% by mass, more preferably 15% by mass to 20% by mass, of the total solid content of the coating liquid. Meanwhile, in the case where the electrical resistance adjuster is a metal oxide, the amount of the electrical resistance adjuster is preferably in the range of 1% by mass to 50% by mass, more preferably 10% by mass to 30% by mass, of the total solid content of the coating liquid. When the foregoing amounts are so small as to be outside the foregoing respective ranges, a desired electrical property cannot be obtained. When the foregoing amounts are so large as to be outside the foregoing respective ranges, there is a decrease in the mechanical strength of the intermediate transfer belt (seamless belt), which is not favorable in practical use.

### <Elastic Layer>

Next, the elastic layer laid over the base layer will be described.

The elastic layer is laid over the base layer, includes spherical resin particles and a layer formed of an elastic body described below, and has a concavo-convex pattern in a surface of the elastic layer. In particular, the elastic layer includes the layer formed of an elastic body laid over the base layer, and the spherical resin particles arranged in a plane direction in the surface of the elastic layer.

—Layer Formed of an Elastic Body—

As the material for the elastic body, for example, a general-purpose material such as a resin, elastomer or rubber can be used, and it is preferable to use a material which has sufficient flexibility (elasticity) to exhibit the effects of the present invention, so that preference is given to an elastomer material and rubber material.

Examples of the elastomer material include thermoplastic elastomers such as polyester elastomers, polyamide elastomers, polyether elastomers, polyurethane elastomers, polyolefin elastomers, polystyrene elastomers, polyacrylic elastomers, polydiene elastomers, silicone-modified polycarbonate elastomers and fluorine copolymer elastomers; and thermosetting elastomers such as polyurethane elastomers, silicone-modified epoxy elastomers and silicone-modified acrylic elastomers.

Examples of the rubber material include isoprene rubber, styrene rubber, butadiene rubber, nitrile rubber, ethylene propylene rubber, butyl rubber, silicone rubber, chloroprene rubber, acrylic rubber, chlorosulfonated polyethylene, fluorine rubber, urethane rubber and hydrin rubber. Among these rubber materials, acrylic rubber is preferable.

It is preferred that a material which can yield an intended performance be suitably selected from the elastomers and the rubbers.

It is particularly preferred that a soft material be selected to conform to the surface state of paper (which serves as a transfer medium or a transfer material) whose surface is provided with protrusions and depressions, for example embossed leather-like paper.

In the present invention, among the above-mentioned materials, use of a thermosetting material is preferable to use of a thermoplastic material in view of formation of spherical resin particles layer (arrangement of spherical resin particles) over the surface of the layer formed of the elastic body. That is, the elastic body of the intermediate transfer belt is preferably cross-linked. The thermosetting material is superior in terms of attachment to the spherical resin particles due to the effects of a functional group contributing to a curing reaction to which the thermosetting material is subjected, and the thermosetting material enables the spherical resin particles to be surely fixed. Use of vulcanized rubber (cross-linked rubber) is preferable as well.

An electrical resistance adjuster for adjusting electrical properties, a flame retardant for yielding flame retardance, and, if necessary, materials such as an antioxidant, a reinforcing agent, filler and a vulcanization accelerator are suitably mixed with the material selected from the above-mentioned materials.

As the electrical resistance adjuster for adjusting electrical properties, any of the above-mentioned materials usable for the electrical resistance adjuster can be used; it should, however, be noted that materials such as carbon black and metal oxides impair flexibility and are preferably used in reduced amounts, and use of an ionic conductive agent, a conductive polymer, etc. is effective as well. Also, the foregoing materials may be used in combination.

The resistance value of the layer formed of the elastic body is preferably adjusted such that the surface resistance value is kept in the range of 1×10⁸ Ω/sq. to 1×10¹³ Ω/sq. and the volume resistance value is kept in the range of 1×10⁶ Ω·cm to 1×10¹² Ω·cm.

The thickness of the layer formed of the elastic body is preferably in the range of approximately 200 μm to approximately 2 mm. When the thickness of the layer is small, it is not favorable because there is a decrease in conformity to the surface conditions of a transfer medium and there is a decrease in transfer pressure reducing effect. When the thickness of the layer is too great, it is not favorable because the layer is heavy, easily bends and easily causes instability in terms of traveling performance, and cracks are easily formed due to the curvature at a roller curvature section provided for setting the belt in a stretched manner.

### —Spherical Resin Particles—

Next, the spherical resin particles buried in the surface of the layer formed of the elastic body are described.

The spherical resin particles are arranged in a plane direction in the surface of the elastic layer to form a concavo-convex pattern in the surface thereof.

A material of the spherical resin particles are not particularly limited and may be suitably selected according to the intended purpose, and examples thereof include resins such as acrylic resins, melamine resins, polyamide resins, polyester resins, silicone resins and fluorine resins. Additionally, the surfaces of the spherical resin particles containing any of these resin materials may be surface-treated with a different material.

Also, materials usable for the spherical resin particles herein stated include rubber material. The surfaces of spherical particles produced using the rubber material may be coated with a hard resin.

Also, the spherical resin particles may be hollow or may be porous.

Among the above-mentioned resins, silicone resins are most favorable in that they have lubricity and are highly capable of imparting abrasion resistance and releasability with respect to toner. That is, the spherical resin particles are particularly preferably silicone resins. When the spherical resin particles are silicone resins, the transfer rate tends to increase.

It is preferred that the spherical resin particles be particles in the shape of spheres produced by a polymerization method or the like, using any such resin; in the present invention, the closer the spherical resin particles are to true spheres, the better.

As for the particle diameter of the spherical resin particles, it is preferred that the volume average particle diameter thereof be in the range of 0.5 μm to 5.0 μm and that the spherical resin particles be monodispersed with a sharp distribution. When the volume average particle diameter is less than 0.5 μm, an effect of enhancing transfer performance cannot be adequately yielded by the particles. When the volume average particle diameter is greater than 5.0 μm, the particles are insulative in many cases, so that if the particle diameter is too large, charge potential remains because of the particles, thereby causing a trouble in which images are disturbed by accumulation of the potential at the time of continuous image printing.

Such spherical resin particles 3 can be uniformly aligned with ease over the layer formed of the elastic body 4 by directly applying powder (spherical resin particles 3) over the layer formed of the elastic body 4 and leveling them.

The volume average particle diameter can be measured by, for example, a laser diffraction method.

It is preferred that a sufficient amount of the spherical resin particles be supplied when applying the spherical resin particles over the layer formed of the elastic body. A small amount of the spherical resin particles would increase the exposed area of the elastic body, which is not covered with the spherical resin particles, to significantly reduce residual toner cleaning property and filming resistance as well as toner transferability.

The projected area rate (particle area rate) of the exposed portions of the spherical resin particles on the surface of the elastic layer is preferably 60% or higher. It is preferred that a sufficient amount of the spherical resin particles be supplied when forming the elastic layer in order to achieve the projected area rate described above. The transfer rate tends to increase with increasing of the particle area rate. It is believed that this is because the higher particle area rate leads to the smaller exposed area of the elastic body which is not covered with the spherical resin particles (the spherical resin particle portions have superior toner transferability to the elastic body portion.) The particle area rate is not particularly limited and may be suitably selected according to the intended purpose, but the particle area rate is preferably from 70% to 90%.

The projected area rate can be determined by observing the surface of the intermediate transfer belt from the direction perpendicular to the surface thereof under a scanning electron microscope at 5,000-fold or 10,000-fold magnification; and then binarize-processing the observed image using an image processing software (IMAGE-PROPLUS; Media Cybernetics, Inc.) to calculate the projected area rate of the elastic body portion and the spherical resin particle portions.

Next, a cross-sectional enlarged schematic drawing of an intermediate transfer belt surface is shown in FIG. 2.

In the present invention, it is preferred that the spherical resin particles 3 be buried in the elastic layer 2, and that the burial rate thereof be greater than 50% but less than 100%. When the burial rate is 50% or less, detachment of the particles easily arises in the case of long-term use in an electrophotographic apparatus, and so the intermediate transfer belt may be inferior in durability. When the burial rate is 100%, it is not favorable because effects on transferability, yielded by the particles, diminish.

In the present invention, it is also preferred that the heights h of exposed portions of the spherical resin particles 3 from the surface of the elastic body (exposed heights) be uniform. The exposed height is preferably uniform enough to satisfy the following expression hₘₐₓ−hₘᵢₙ≦0.2 μm wherein hₘₐₓ is the maximum exposed height and hₘᵢₙ is the minimum exposed height. The structure that there is great variability among exposed heights and thus the expression defined above is not satisfied, as shown in FIG. 3, is not preferable because the resulting belt surface has large protrusions and large depressions, so that residual-toner cleanability results in reduced particularly in a cleaning operation using a cleaning blade, and contaminants are made easier to attach to depressions. The value of hₘₐₓ−hₘᵢₙ is preferably 0.01 μm or higher.

The exposed height denoted by h is the height of the exposed portion of each spherical resin particle from the surface 4a of the layer formed of the elastic body 4 when observing the cross-section of the intermediate transfer belt under a scanning electron microscope at 5,000-fold or 10,000-fold magnification, the maximum exposed height is denoted by “hₘₐₓ” and the minimum exposed height is denoted by “hₘᵢₙ.”

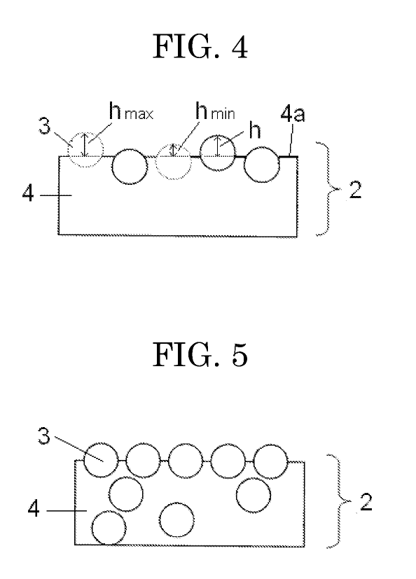

Referring to FIG. 4, an example of the method for measuring “hₘₐₓ” and “hₘᵢₙ” will now be described. First, the cross-section of the intermediate transfer belt is observed under a scanning electron microscope at 5,000-fold or 10,000-fold magnification and then the height h of the exposed portion of each spherical resin particle 3 from the surface 4a of the layer formed of elastic body 4 in the direction perpendicular to the surface 4a (exposed height) is determined. The maximum exposed height is denoted by “hₘₐₓ” and the minimum exposed height is denoted by “hₘᵢₙ.” When the cross-sectional diameter of a spherical resin particle obtained from the cross-sectional observation is equal to or smaller than the half of the average diameter of the spherical resin particles, such a particle shall be excluded from subjects for the determination of the exposed height described above.

As such, the intermediate transfer belt having the layer with uniform outermost surface heights of the particles has glossiness of 35% or higher as determined based on reflected light at 85° on the surface of the intermediate transfer belt.

The more uniform the height of the particle's outermost surface is, the higher glossiness as determined based on reflected light at 85° on the surface of the intermediate transfer belt becomes. The intermediate transfer belt having the layer with uniform outermost surface heights of the particles is improved in belt cleanability and reduced in attachment of contaminants to the depressions. Thus, it is believed that the intermediate transfer belt having higher glossiness at 85° is less susceptible to adverse effects caused by, for example, attachment of contaminants, leading to high transferability. However, the effect of glossiness at 85° is probably lower than that of the foregoing “particle area rate” and “type of the particle material.”

It is preferred that the spherical resin particles 3 are arranged in a plane direction in the surface of the elastic layer 2, and the spherical resin particles form a single layer with respect to the thickness direction of the elastic layer. If a plurality of particles is present with respect to the thickness direction of the elastic layer, as shown in FIG. 5, the distribution of the spherical resin particles contained is uneven and the belt surface has ununiform electrical properties, affected by the electrical resistance value of the spherical resin particles, thereby disturbing images. Specifically, at portions where the spherical resin particles are present in large amounts, the electrical resistance value is high and surface potential is generated owing to residual charge; thus, there is a variation in surface potential at the belt surface, and disturbance of images is tangible, for example owing to a difference in image density between adjacent portions.

### (Method for Producing Intermediate Transfer Belt)

A method of the present invention for producing an intermediate transfer belt includes: forming a base layer; forming a layer formed of a elastic body over the base layer; uniformly applying spherical resin particles over the layer formed of the elastic body; and arranging and burying the spherical resin particles in the layer formed of the elastic body and uniformly leveling the spherical resin particles; and may, if necessary, include other steps.

Next, an example of the method of the present invention for producing the intermediate transfer belt will be described.

First, a production method of a base layer (a forming step of a base layer) is described.

A method of producing a base layer with the use of a coating liquid containing at least a resin component, i.e., a coating liquid containing the polyimide resin precursor or the polyamide-imide resin precursor, is now described.

A surface of a cylindrical support (mold) can be coated with a base substance containing the polyimide resin or the polyamide-imide resin with the use of a coating method such as a spiral coating using a nozzle or a dispenser, a die coating using a wide die, or a roll coating using an application roller. The roll coating is now described.

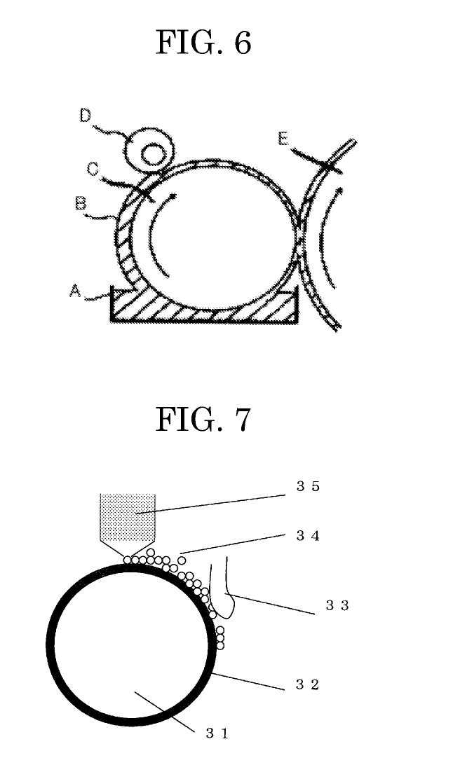

The coating method can be performed using a devise shown in FIG. 6. Reference character “A” denotes a paint pan for storing a degassed precursor liquid (paint B), reference character “C” denotes an application roller for continuously drawing the paint B up from the paint pan A, reference character “D” denotes a control roller for adjusting the thickness of the paint B continuously drawn up from the paint pan A to the predetermined paint thickness between the application roller C and the control roller, and reference character “E” denotes a cylindrical support (metal mold) with which the paint (coating) having the predetermined thickness moves and attaches from the application roller C thereto.

The fully predegassed precursor paint (paint B) is first poured into the paint pan A in the producing devise described above. The viscosity of the paint has been preferably adjusted to a value between 0.5 Pa·s and 10 Pa·s using a polar organic solvent which may be a well-known, conventional solvent. The bottom portion of the application roller C is then approached toward the paint pan A containing the paint B and immersed in the paint B. The paint B is then attached to the surface of the application roller C and drawn up by the application roller C at a slow peripheral velocity from 10 mm/sec to 100 mm/sec. Subsequently, the thickness of the paint B on the surface of the application roller C is adjusted by the control roller D which is installed above the application roller C and capable of adjusting the any gap between the application roller C and the control roller D. The thickness of the paint B is preferably controlled to be about twice as thick as that of the paint B when transferred to the cylindrical support E.

The cylindrical support E, while being slowly rotated, is then approached toward the application roller C by the distance equal to or shorter than the thickness of the paint B on the surface of the application roller C. The paint B on the surface of the application roller C is transferred from the application roller C to the cylindrical support E rotating in the same direction as the application roller C (“clockwise direction” in FIG. 6). Thus, the paint whose thickness is predetermined is attached to the cylindrical support E.

After the application, with the cylindrical support kept rotating, the solvent in the coating film is evaporated at approximately 80° C. to approximately 150° C. gradually increasing the temperature. In this process, it is preferable to remove vapor (the volatilized solvent, etc.) in the atmosphere by efficient circulation. When a film with a self-supporting property has been formed, this film and the mold are moved into a heating furnace (firing furnace) capable of high-temperature treatment, then the temperature is increased in steps and high-temperature heating (firing) is performed finally at approximately 250° C. to approximately 450° C. so as to sufficiently make the polyimide resin precursor or the polyamide-imide resin precursor into a polyimide resin or a polyamide-imide resin.

Cooling is sufficiently carried out, and then the layer formed of the elastic body is formed over the base layer.

The layer formed of the elastic body can be made by applying on the base layer a rubber base paint which contains rubber dissolved in an organic solvent, drying the solvent, and vulcanizing the rubber. Similar to the base layer, the existing coating method including the spiral coating, the die coating, or the roll coating and so on can be used, but the die coating and the spiral coating which can form a thick coating film are preferable, since the thicker coating is required to form in order to enhance the transferability of a concavo-convex pattern in the surface. The spiral coating is now described. The rubber base paint is spirally coated on the base layer by continuously supplying the rubber base paint using a circular or a wide nozzle while moving the nozzle in an axial direction of the base layer and rotating the base layer in a circumferential direction. The rubber base paint spirally coated on the base layer is dried in parallel with leveling by keeping the predetermined rotating speed and the predetermined drying temperature.

When the coating film has been sufficiently leveled, a powder supplying device 35 and a pushing member 33 are placed as shown in FIG. 7; subsequently, while the cylindrical support is being rotated, spherical resin particles 34 are evenly sprinkled over the surface of the layer formed of the elastic body 34, then the pushing member 33 is pushed under a constant pressure against the spherical resin particles 34 sprinkled over the surface. By means of the pushing member 33, the spherical resin particles 34 are buried in the layered body 32 which includes the base layer supported by the metal mold drum 31 and the layer formed of the elastic body while removing the excess spherical resin particles 34. In the present invention, the use of monodisperse spherical resin particles makes it possible to form a uniform, single particle layer by a simple process that only involves the foregoing leveling performed by the pushing member 33.

The burial rate of the spherical resin particles in the elastic layer can be easily adjusted by for example altering the pushing force of the pushing member 33, but other methods may be used. Although it depends on for example the viscosity of the cast-coating liquid, the resin content, the amount of the solvent used, and the material of the resin. In one example, the expressions “50% <burial rate <100%” and “hₘₐₓ−hₘᵢₙ≦0.2 μm” can be relatively easily achieved if the viscosity of the cast-coating liquid is from 100 mPa·s to 100,000 mPa·s and the pushing force is from 10 mN/cm to 1,000 mN/cm.

After the formation of the uniform particle layer, this layer is cured by being heated at a predetermined temperature for a predetermined time thereby forming the elastic layer.

The seamless belt produced by the above-mentioned method can, for example, be suitably used as an intermediate transfer belt for an electrophotographic apparatus of intermediate transfer type, wherein a plurality of developed color toner images sequentially formed over an image bearing member are primarily transferred by being sequentially superimposed onto one another over the intermediate transfer belt, and the primarily transferred images are secondarily transferred onto a transferred medium (recording medium) at one time. With the seamless belt, it is possible to construct an electrophotographic apparatus capable of forming high-quality images.

(Image forming Apparatus)

An image forming apparatus of the present invention is characterized by including the above-mentioned intermediate transfer belt of the present invention.

One exemplary image forming apparatus of the present invention includes an image bearing member (also called a “photoconductor”), a latent electrostatic image forming unit configured to form a latent electrostatic image on the image bearing member, a developing unit configured to develop the latent electrostatic image formed on the image bearing member using a toner so as to form a toner image, a primary transfer unit configured to transfer the toner image on the image bearing member onto a intermediate transfer belt of the present invention, a secondary transfer unit configured to transfer the toner image on the intermediate transfer belt onto a recording medium, and a fixing unit configured to fix the toner image on the recording medium.

Referring to main-part schematic drawings, the following specifically explains a seamless belt (intermediate transfer belt of the present invention) for use in a belt formation unit installed in the image forming apparatus according to the present invention. Note that each schematic drawing merely shows an example and the present invention is not confined thereto.

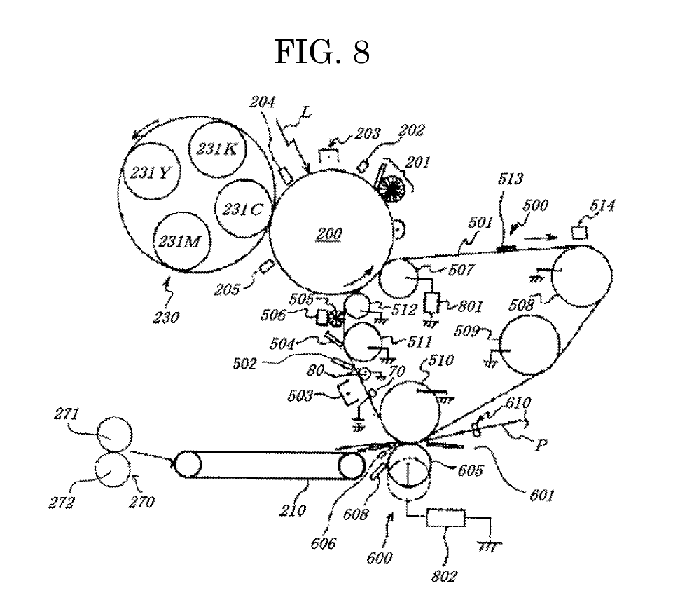

FIG. 8 is a main-part schematic drawing for explaining an image forming apparatus wherein an intermediate transfer belt according to the present invention is installed.

An intermediate transfer unit 500 shown in FIG. 8, incorporates members such as an intermediate transfer belt 501 serving as an intermediate transfer member that is set in a stretched manner on a plurality of rollers. Around this intermediate transfer belt 501, members including the following are disposed in such a manner as to face the belt: a secondary transfer bias roller 605 serving as a secondary transfer charge supplying unit of a secondary transfer unit 600, a belt cleaning blade 504 serving as an intermediate transfer member cleaning unit, and a lubricant applying brush 505 serving as a lubricant applying member of a lubricant applying unit.

Also, a mark (not shown in the drawing) for positional detection is provided on the outer circumferential surface or inner circumferential surface of the intermediate transfer belt 501. Note that in the case where the mark for positional detection is provided on the outer circumferential surface side of the intermediate transfer belt 501, it is necessary to make a skillful attempt and provide the mark so as not to be present in areas where the belt cleaning blade 504 passes, and this often involves difficulty in terms of placement; accordingly, in that case, the mark for positional detection may be provided on the inner circumferential surface side of the intermediate transfer belt 501. An optical sensor 514 serving as a mark detecting sensor is provided at a position between a belt driving roller 508 and a primary transfer bias roller 507 serving as a primary transfer unit on which the intermediate transfer belt 501 is set.

The inner circumferential surface of the intermediate transfer belt 501 is provided with a charge-eliminating roller 70 for eliminating accumulated charge and an earthed earth roller 80.

The intermediate transfer belt 501 is set in a stretched manner on the primary transfer bias roller 507 serving as a primary transfer charge supplying unit, the belt driving roller 508, a belt tension roller 509, a secondary transfer opposed roller 510, a cleaning opposed roller 511 and a feedback current detecting roller 512. Each roller is formed of a conductive material, and the rollers except the primary transfer bias roller 507 are earthed. A transfer bias controlled to have a predetermined electric current or a predetermined voltage according to the number of toner images superimposed onto one another is applied to the primary transfer bias roller 507 by a primary transfer power source 801 controlled to have a constant electric current or a constant voltage.

The intermediate transfer belt 501 is driven in the direction of the arrow (the clockwise direction) by the belt driving roller 508 which is rotationally driven in the direction of the arrow by a drive motor (not shown).

In general, the intermediate transfer belt 501 serving as a belt member is semiconductive or insulative and has a single-layer or multilayer structure; in the present invention, a seamless belt is preferably used as the intermediate transfer belt, and the use thereof improves durability and realizes superior image formation. Also, to allow toner images formed over a photoconductor drum 200 to be superimposed onto one another over the intermediate transfer belt, the intermediate transfer belt is made larger than the maximum size of paper allowed to be fed.

The secondary transfer bias roller 605 serving as a secondary transfer unit is constructed in such a manner as to be able to touch and separate from the outer circumferential surface of the intermediate transfer belt 501 at the part where the intermediate transfer belt 501 is set in a stretched manner on the secondary transfer opposed roller 510 by an attaching and detaching mechanism serving as an attaching and detaching unit described below. The secondary transfer bias roller 605 is placed such that transfer paper P serving as a transferred medium (recording medium) can be sandwiched between the secondary transfer bias roller 605 and the intermediate transfer belt 501 at the part where the intermediate transfer belt 501 is set in a stretched manner on the secondary transfer opposed roller 510, and a transfer bias having a predetermined electric current is applied by a secondary transfer power source 802 controlled to have a constant electric current.

At a predetermined timing, a registration roller 610 sends transfer paper P as a transfer medium (transfer material) to the part between the secondary transfer bias roller 605 and the intermediate transfer belt 501 set in a stretched manner on the secondary transfer opposed roller 510. A cleaning blade 608 serving as a cleaning unit is in contact with the secondary transfer bias roller 605. The cleaning blade 608 performs cleaning by removing matter attached to the surface of the secondary transfer bias roller 605.

In a color copier having such a structure, when an image formation cycle starts, the photoconductor drum 200 is rotated by a drive motor (not shown) in a counterclockwise direction as shown by the arrow, and a Bk (black) toner image, a C (cyan) toner image, an M (magenta) toner image and a Y (yellow) toner image are formed over the photoconductor drum 200. The intermediate transfer belt 501 is rotated by the belt driving roller 508 in a clockwise direction as shown by the arrow. As the intermediate transfer belt 501 rotates, the Bk toner image, the C toner image, the M toner image and the Y toner image are primarily transferred by the transfer bias created by the voltage applied to the primary transfer bias roller 507, and finally the toner images are formed over the intermediate transfer belt 501 in a superimposed manner in the order of Bk, C, M and Y.

For example, the Bk toner image is formed as follows.

In FIG. 8, by corona discharge, a charger 203 serving as a charging unit uniformly charges the surface of the photoconductor drum 200 with a negative charge and to a predetermined potential. With the timing being set based upon a signal for detection of the mark on the belt, raster exposure is performed with laser light by a writing optical unit (not shown; may be referred to as an exposing unit) based upon a signal for a Bk image. The charging unit and the exposing unit may be together referred to as a latent electrostatic image forming unit. When the image has been subjected to the raster exposure, charge in proportion to the exposure amount disappears at the exposed portion of the uniformly charged surface of the photoconductor drum 200 and a Bk latent electrostatic image is formed there. By contact between a negatively-charged Bk toner on a developing roller of a Bk developing device 231K and the Bk latent electrostatic image, the toner is not attached to portions of the photoconductor drum 200 where the charge remains, the toner adsorbs to portions where there is no charge, in other words exposed portions, and a Bk toner image which approximates to the latent electrostatic image is thus formed.

The Bk toner image thus formed over the photoconductor drum 200 is primarily transferred to the outer circumferential surface of the intermediate transfer belt 501 rotationally driven at a speed equal to and in contact with the photoconductor drum 200. Untransferred residual toner slightly remaining on the surface of the photoconductor drum 200 subsequent to the primary transfer is cleaned off by a photoconductor cleaning device 201 to prepare for reuse of the photoconductor drum 200. Regarding the photoconductor drum 200, a C image forming step takes place subsequent to the Bk image forming step, then a color scanner starts to read C image data at a predetermined timing, and a C latent electrostatic image is formed over the surface of the photoconductor drum 200 by writing with laser light based upon the C image data.

After passage of a rear end of the Bk latent electrostatic image and before arrival of a front end of the C latent electrostatic image, a revolver developing unit 230 serving as a developing unit is rotated, a C developing device 231C is set at a development position, and the C latent electrostatic image is developed with a C toner. The C latent electrostatic image area continues being developed; when a rear end of the C latent electrostatic image has passed, a revolver developing unit is rotated as in the case of the Bk developing device 231K mentioned earlier, and an M developing device 231M for a subsequent process is moved to the development position. This movement is completed before a front end of a Y latent electrostatic image for a subsequent process arrives at the development position. Explanations of an M image forming step using the M developing device 231M and a Y image forming step using the Y developing device 231Y are omitted on the grounds that they are similar to the above-mentioned Bk image forming step and the above-mentioned C image forming step in terms of reading of color image data, formation of a latent electrostatic image and developing operation.

At that time, an electric potential on the photoconductor drum 200 after being exposed to laser light L is measured using an electric potential sensor 204, and the toner density on the photoconductor drum 200 after being developed by the developing device 231 is measured using an image density sensor 205. The results from the above measurements are feedbacked.

The Bk, C, M and Y toner images sequentially formed over the photoconductor drum 200 as just described are sequentially positioned and primarily transferred onto the same surface of the intermediate transfer belt 501. Thus, toner images (toner image 513) with a maximum of four colors combined together are formed over the intermediate transfer belt 501. Meanwhile, at the time when the image formation starts, transfer paper P is fed from a paper feed unit such as a transfer paper cassette or a manual feed tray and waits at a nip section of the registration roller 610.

Once a front end of the combined toner images on the intermediate transfer belt 501 nears a secondary transfer section where a nip section is formed by the secondary transfer bias roller 605 and the intermediate transfer belt 501 set in a stretched manner on the secondary transfer opposed roller 510, the registration roller 610 is driven such that a front end of the transfer paper P corresponds with the front end of the combined toner images, the transfer paper P is conveyed along a transfer paper guiding plate 601, and registration of the transfer paper P and the combined toner images is adjusted.

Thus, when the transfer paper P passes through the secondary transfer section, the four-color combined toner images on the intermediate transfer belt 501 are transferred (secondarily transferred) at one time onto the transfer paper P by a transfer bias created by a voltage applied to the secondary transfer bias roller 605 by the secondary transfer power source 802. The transfer paper P is conveyed along the transfer paper guiding plate 601, then subjected to charge elimination by passing through a section that faces a transfer paper charge-eliminating charger 606 that includes a charge eliminator placed downstream of the secondary transfer section, and subsequently sent toward a fixing device 270 serving as a fixing unit by a belt conveying device 210 serving as a belt formation unit. The toner image is melted and fixed onto the transfer paper Pat a nip section of fixing rollers 271 and 272 of the fixing device 270, then the transfer paper P is sent to the outside of the apparatus by a discharge roller (not shown) and laid over a copy tray (not shown) with the printed side facing upward. Note that the fixing device 270 may, if necessary, be provided with a belt formation unit.

Meanwhile, the surface of the photoconductor drum 200 having undergone the transfer of the images to the belt is cleaned by the photoconductor cleaning device 201 and uniformly subjected to charge elimination by a charge-eliminating lamp 202. Residual toner remaining on the outer circumferential surface of the intermediate transfer belt 501 subsequent to the secondary transfer of the toner images onto the transfer paper P is cleaned off by the belt cleaning blade 504 after being charged by the charger 503. The belt cleaning blade 504 is made to touch and separate from the outer circumferential surface of the intermediate transfer belt 501 at a predetermined timing by a cleaning member attaching and detaching mechanism (not shown).

A toner sealing member 502 that touches and separates from the outer circumferential surface of the intermediate transfer belt 501 is provided upstream of the belt cleaning blade 504 with respect to the moving direction of the intermediate transfer belt 501. The toner sealing member 502 receives toner that has fallen from the belt cleaning blade 504 at the time of the cleaning off of the residual toner and prevents the toner that has fallen from scattering over the conveyance path of the transfer paper P. The toner sealing member 502 is made to touch and separate from the outer circumferential surface of the intermediate transfer belt 501 along with the belt cleaning blade 504 by the cleaning member attaching and detaching mechanism.

Over the outer circumferential surface of the intermediate transfer belt 501 from which the residual toner has been removed as just described, a lubricant 506 shaved off by the lubricant applying brush 505 is applied. The lubricant 506 is made of a solid material such as zinc stearate and placed so as to be in contact with the lubricant applying brush 505. Residual charge remaining on the outer circumferential surface of the intermediate transfer belt 501 is removed with a charge-eliminating bias applied by a belt charge-eliminating brush (not shown) that is in contact with the outer circumferential surface of the intermediate transfer belt 501.

Here, the lubricant applying brush 505 and the belt charge-eliminating brush are made to touch and separate from the outer circumferential surface of the intermediate transfer belt 501 at a predetermined timing by respective attaching and detaching mechanisms (not shown).

Here, regarding operation of the color scanner and formation of images over the photoconductor drum 200 during repeated copy, a step of forming an image of the fourth color (Y) over a first sheet of transfer paper is followed at a predetermined timing by a step of forming an image of the first color (Bk) over a second sheet of transfer paper. Following the step of transferring four-color combined toner images to the first sheet of the transfer paper at one time, a Bk toner image for the second sheet is primarily transferred to the area on the outer circumferential surface of the intermediate transfer belt 501, cleaned by the belt cleaning blade 504. Thereafter, an operation similar to that for the first sheet is performed. The foregoing is a copy mode for obtaining a full-color copy composed of the four colors; in the case where a three-color copy mode or a two-color copy mode is selected, a similar operation is performed for the designated colors and the designated number of times. In the case of a single-color copy mode, only the developing device of the predetermined color in the revolver developing unit 230 is left to conduct image development and copying operation is performed with the belt cleaning blade 504 left in contact with the intermediate transfer belt 501, until transfer of images to a predetermined number of sheets finishes.

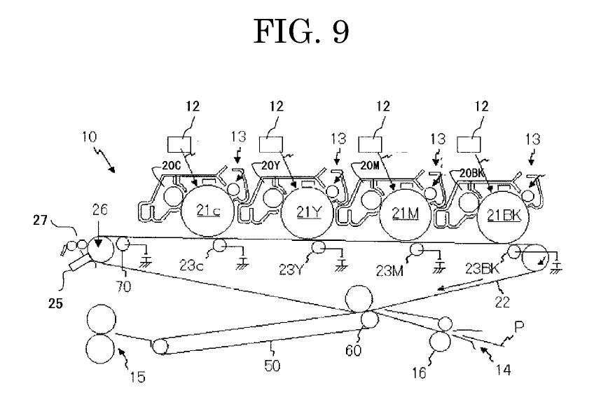

In the above embodiment, a copier provided with only one photoconductor drum 200 has been described; note that the present invention can also be applied, for example, to an electrophotographic apparatus wherein a plurality of photoconductor drums are aligned along one intermediate transfer belt that is a seamless belt, a structural example of which is shown in the main-part schematic drawing of FIG. 9.

FIG. 9 shows a structural example of a digital color printer of four-drum type, provided with four photoconductor drums 21Bk, 21Y, 21M and 21C for forming toner images of four different colors (black, yellow, magenta and cyan).

In FIG. 9, a printer main body 10 includes image writing units 12 serving as an exposing unit, image forming units 13 and a paper feed unit 14 that are provided for performing electrophotographic color image formation. Based upon an image signal, image processing is carried out in an image processing unit to convert the image signal to signals of black (Bk), magenta (M), yellow (Y) and cyan (C) for image formation, and these signals are sent to the image writing units 12. The image writing units 12 are, for example, laser scanning optical systems each composed of a laser light source, a deflector such as a rotary polygon mirror, a scanning image-forming optical system and a group of mirrors, and respectively include four writing optical paths that correspond to the signals of each color, thereby writing images onto the image bearing members (photoconductors) 21Bk, 21M, 21Y and 21C for each color in the image forming units 13 based upon the signals of each color.

The image forming units 13 respectively include the photoconductors 21Bk, 21M, 21Y and 21C serving as image bearing members for black (Bk), magenta (M), yellow (Y) and cyan (C). As the photoconductors for each color, OPC photoconductors (organic photoconductors) are generally used. Around the photoconductors 21Bk, 21M, 21Y and 21C, the following members are provided: charging devices serving as a charging unit; exposing units using laser light from the image writing units 12; developing devices 20Bk, 20M, 20Y and 20C serving as a developing unit for black, magenta, yellow and cyan respectively; primary transfer bias rollers 23Bk, 23M, 23Y and 23C as primary transfer units; cleaning devices (not shown); photoconductor charge-eliminating devices (not shown); and so forth. The exposing unit (image writing unit 12) and the charging unit may be collectively referred to as a latent electrostatic image forming unit. The developing devices 20Bk, 20M, 20Y and 20C employ a developing method with two-component magnetic brushes. An intermediate transfer belt 22 serving as a belt formation member lies between the photoconductors 21Bk, 21M, 21Y and 21C and the primary transfer bias rollers 23Bk, 23M, 23Y and 23C, is set in a stretched manner on the driving roller 26 and other rollers, and is driven in the clockwise direction by the belt driving roller 26 while toner images of each color formed over the respective photoconductors being sequentially superimposed onto one another over the intermediate transfer belt 22 and thus transferred.

Transfer paper P is fed from the paper feed unit 14 and then borne on a transfer conveyance belt 50 serving as a belt formation member, with the aid of a registration roller 16. The toner images transferred onto the intermediate transfer belt 22 are secondarily transferred (transferred at one time) by a secondary transfer bias roller 60 as a secondary transfer unit, at the part where the intermediate transfer belt 22 and the transfer conveyance belt 50 come into contact with each other. Thus, a color image is formed over the transfer paper P. The transfer paper P with the color image formed thereon is conveyed to a fixing device 15 serving as a fixing unit by the transfer conveyance belt 50 so as to fix the transferred image by this fixing device 15, then the transfer paper P with the fixed image is discharged to the outside of the printer main body.

Residual toner remaining on the intermediate transfer belt 22, which was not transferred at the time of the secondary transfer, is removed from the intermediate transfer belt 22 by a belt cleaning member 25. A lubricant applying device 27 is placed downstream of the belt cleaning member 25. This lubricant applying device 27 includes a solid lubricant, and a conductive brush to apply the solid lubricant by rubbing against the intermediate transfer belt 22. Being always in contact with the intermediate transfer belt 22, the conductive brush applies the solid lubricant over the intermediate transfer belt 22. The solid lubricant has the function of enhancing the cleanability of the intermediate transfer belt 22, preventing the occurrence of filming, and improving the durability of the intermediate transfer belt 22. Reference numeral 70 denotes a charge-eliminating roller.

The present invention can provide an electrophotographic apparatus which is capable of keeping a high transfer performance not just initially but over a long period of time regardless of the type and the surface conditions of a transfer medium, which has high durability, and which can form high-quality images.

The present invention will next be described by way of Examples. The present invention, however, should not be construed as being limited to the Examples. The suitably modified embodiments are also within the scope of the present invention without departing from the spirit of the present invention.

### EXAMPLES

### Example 1

A coating liquid for a base layer was prepared as described below, and a seamless belt base layer was produced using this coating liquid.

### <Preparation of Coating Liquid for Base Layer A>

Firstly, a dispersion liquid prepared beforehand by dispersing carbon black (SPECIAL BLACK 4; from Evonik Degussa) in N-methyl-2-pyrrolidone using a bead mill was mixed with a polyimide varnish (U-VARNISH A; from Ube Industries, Ltd.) composed mainly of a polyimide resin precursor, such that the carbon black content became 17% by mass of the polyamic acid solid content, then sufficient stirring was performed, and a coating liquid for a base layer A was thus prepared.

### <Production of Seamless Belt>

Secondly, using as a mold a metal cylindrical support (outer diameter: 340 mm, length: 360 mm) whose outer surface had been roughened by blasting, the cylindrical support was installed in the roll coating coater shown in FIG. 6.

The coating liquid for the base layer A was then poured into the paint pan and drawn up with the rotating speed of the application roller at 40 mm/sec. The thickness of the paint on the surface of the application roller was controlled by adjusting the gap between the application roller and the control roller to 0.6 mm. The cylindrical support was then approached toward the application roller while the rotating speed of the cylindrical support was being controlled at 35 mm/sec. The paint on the surface of the application roller was uniformly transferred to the cylindrical support with the gap between the application roller and the cylindrical support at 0.4 mm. After that, while keeping the cylindrical support rotated, heating was carried out for 30 minutes using a hot-air circulation dryer, with the temperature gradually increased to 110° C. With a further increase in temperature to 200° C., heating was carried out for 30 minutes, the rotation was stopped, and then set in a heating furnace (firing furnace) capable of high-temperature treatment, and heat treatment (firing) was carried out for 60 minutes with the temperature increased to 320° C. in steps.

<Production of Elastic Layer over Base Layer>

Firstly, the constituent materials below were mixed together and then sufficiently kneaded using a biaxial kneader to produce a rubber composition.

### <Constituent Material of Elastic Layer (Rubber Composition)>

| | | |
|---|---|---|
| Acryl rubber: | 100 | parts by mass |
| NIPOL AR12 (product of ZEON | | |
| CORPORATION.) | | |
| Stearic acid: | 1 | part by mass |
| STEARIC ACID CAMELLIA BEAD (product | | |
| of NOF CORPORATION.) | | |
| Red phosphorus: | 10 | parts by mass |
| RINKA FE 140F (product of RINKAGAKU | | |
| KOGYO CO., LTD.) | | |
| Aluminium hydroxide: | 60 | parts by mass |
| HIGILITE H42M (product of Showa Denko | | |
| K.K.) | | |
| Closslinking agent: | 0.6 | part by mass |
| Diak. No1 (hexamethylenediaminecarbamate; | | |
| product of DuPont Performance Elastomers | | |
| L.L.C.) | | |
| Crosslinking accelerator: | 1 | part by mass |
| VULCOFAC ACT55 (70% a salt of 1,8- | | |
| diazabicyclo (5,4,0) undecene-7 and a dibasic | | |
| acid, 30% amorphous silica; product of | | |
| Safic-Alcan) | | |
| Conducting agent: | 0.3 | part by mass |
| QAP-01 (tetrabutylammonium perchlorate; | | |
| product of Japan Carlit Co., Ltd.) | | |

The rubber composition prepared as described above was dissolved in an organic solvent (MIBK: methyl isobutyl ketone) to form a rubber solution containing a solid content of 35 percent by mass. This rubber solution was spirally coated on the polyimide base layer by continuously supplying the rubber solution using a nozzle while moving the nozzle in an axial direction of the cylindrical support and rotating the cylindrical support on which the polyimide base layer previously formed in a circumferential direction. The coating amount was set so that the final layer thickness was adjusted to 500 μm.

At the point when all of a predetermined amount of the coating liquid had been applied and then uniformly spread on the outer surface of the cylindrical support, silicone resin particles (X-52-854 (volume average particle diameter: 0.8 μm; monodisperse particles); from Shin-Etsu Chemical Co., Ltd.) as spherical resin particles were evenly sprinkled over the surface in a manner shown in FIG. 7. Then, a pushing member of a polyurethane rubber blade was pushed against the spherical resin particles at a pushing force of 50 mN/cm to fix the spherical resin particles to the elastic layer.

After the entire belt surface had finished undergoing the above-mentioned treatment, the cylindrical support coated with the rubber solution was placed in a hot-air circulation dryer while the cylindrical support being rotated, and then heated for 30 minutes with the temperature being increased to 90° C. at a temperature increase rate of 4° C./min. Then, continuously, the cylindrical support was heated for 60 minutes with the temperature increased to 170° C. at a temperature increase rate of 4° C./min. Subsequently, the rotation was stopped, and then the cylindrical support was gradually cooled. After the cylindrical support had been thoroughly cooled, the resultant laminate was separated from the metal mold thereby forming an intermediate transfer member A.

### Example 2

An intermediate transfer belt B was obtained in the same manner as in Example 1 except that the spherical resin particles were changed to silicone resin particles (KMP 701 (volume average particle diameter: 3.5 μm, monodisperse particles); from Shin-Etsu Chemical Co., Ltd.).

### Example 3

An intermediate transfer belt C was obtained in the same manner as in Example 1 except that the spherical resin particles were changed to silicone resin particles (TOSPEARL 120 (volume average particle diameter: 2.0 μm; monodisperse particles); from Momentive Performance Materials Inc.).

### Example 4

An intermediate transfer belt D was obtained in the same manner as in Example 1 except that the spherical resin particles were changed to silicone resin particles (TOSPEARL 2000B (volume average particle diameter: 6.0 μm; monodisperse particles); from Momentive Performance Materials Inc.).

### Example 5

An intermediate transfer belt E was obtained in the same manner as in Example 1 except that the spherical resin particles were changed to acrylic resin particles (MMB-0320 (volume average particle diameter: 3.5 μm; monodisperse particles); JX Nippon Oil & Energy Corporation).

### Examples 6 to 8

Intermediate transfer belts F, G and H were obtained in the same manner as in Example 2 except that the pushing force of the pushing member shown in FIG. 7 was changed to 100 mN/cm, 500 mN/cm, and 750 mN/cm, respectively.

### Comparative Example 1

An intermediate transfer belt I was produced in the same manner as in Example 1 except that the particle layer was not formed (i.e., the elastic layer contains no spherical resin particles).

### Comparative Example 2

An intermediate transfer belt J was produced in the same manner as in Example 1 except that as spherical resin particles the particles was used which had been produced by thoroughly mixing the equal masses of silicone resin particles (X-52-854 (volume average particle diameter 0.8 μm; monodisperse particles); from Shin-Etsu Chemical Co., Ltd.) and silicone resin particles (TOSPEARL 2000B (volume average particle diameter: 60 μm; monodisperse particles); from Momentive Performance Materials Inc.), and the pushing member was not pushed against the particles after being sprinkled.

### Comparative Example 3

An intermediate transfer belt K was produced in the same manner as in Example 1 except that the sufficient amount of spherical resin particles were not supplied in the sprinkling step (i.e. the lower amount of spherical resin particles was sprinkled).

### Comparative Example 4

An intermediate transfer belt L was produced in the same manner as in Example 1 except that as spherical resin particles the particles was used which had been produced by thoroughly mixing the equal masses of silicone resin particles (TOSPEARL 120 (volume average particle diameter: 2.0 μm; monodisperse particles); from Momentive Performance Materials Inc.) and silicone resin particles (TOSPEARL 130 (volume average particle diameter: 3.0 μm; monodisperse particles); from Momentive Performance Materials Inc.), and the pushing member was not pushed against the particles after being sprinkled.

The following evaluations were carried out against each of the intermediate transfer belts A to L of Examples and Comparative Examples.

### <Measurement of Glossiness>

Surface glossiness was measured based on reflected light at 60° or 85° on the surface of each of the belts (i.e., the surface glossiness was measured based on reflected light observed when light was applied to the surface of the belt at an incident angle of 60° or 85°) using a hand-held glossmeter (PG-1M; Nippon Denshoku Industries Co., Ltd.). An average of glossiness at ten locations was used as the measurement data.

### <Measurement of Exposed Height of Spherical Resin Particles>

The cross-section of each of the belts was observed under a scanning electron microscope at 5,000-fold or 10,000-fold magnification; and then with the use of the observed image, the height h of the exposed portion of each spherical resin particle from the surface of the layer formed of elastic body (exposed height) was calculated. The difference between the maximum exposed height “hₘₐₓ” and the minimum exposed height “hₘᵢₙ”; i.e., “hₘₐₓ−hₘᵢₙ” was calculated.

The cross-section of each of the belts was observed at 10,000-fold when particles having a volume average particle diameter of less than 3.5 μm were contained, and at 5,000-fold magnification when particles having a volume average particle diameter of 3.5 μm or more were contained.

### <Measurement of Particle Area Rate of Belt Surface>

The projected area rate of the elastic body portions and the spherical resin particles portions can be determined by observing the surface of the belt from the direction perpendicular to the surface under a scanning electron microscope at 5,000-fold or 10,000-fold magnification; and then binarize-processing the observed image using an image processing software (IMAGE-PROPLUS; Media Cybernetics, Inc.) to calculate the projected area rate of both the portions.

The cross-section of each of the belts was observed at 10,000-fold when particles having a volume average particle diameter of less than 3.5 μm were contained, and at 5,000-fold magnification when particles having a volume average particle diameter of 3.5 μm or more were contained.

Additionally, the following evaluations were carried out, installing each of the intermediate transfer belts A to L of Examples and Comparative Examples in the electrophotographic apparatus shown in FIG. 9.

### <Measurement of Transfer Rate>

A blue solid image was printed onto paper (embossed leather-like paper; ream weight: 215 kg) whose surface had concavo-convex patterns, used as transfer paper, then the amount of toner on the intermediate transfer belt before transfer of the image to the paper and the amount of toner remaining on the intermediate transfer belt after the transfer of the image to the paper were measured, and the transfer rate was calculated in accordance with Equation 1 below.

$$Transfer rate ( \% ) = ( 1 - \frac{Amount of toner on belt after transfer ( g )}{Amount of toner on belt before transfer ( g )} ) \times 100 \qquad Equation 1$$

<Measurement of Transfer Rate when Image Had Been Continuously Printed onto 10,000 Sheets of Paper>

After a test chart had been continuously printed onto 10,000 sheets of paper, the printing was halted, and the transfer rate was measured as described above.

<Evaluation of Image when Image Had Been Continuously Printed onto 10,000 Sheets of Paper>

After a test chart had been continuously printed onto 10,000 sheets of paper, a single-color halftone image of cyan was printed onto the entire surface of paper (embossed leather-like paper) of 215 kg in ream weight, and an observation was carried out regarding the presence, absence or extent of an abnormal image.

The results are shown Table 1.

TABLE 1

| | | | | | | | After printing of image onto 10,000 | | |
|---|---|---|---|---|---|---|---|---|---|
| | | Initial | | | | | sheets of paper | | |
| | | | | | Particle | Transfer | Transfer | | |
| | | Glossiness | Glossiness | hₘₐₓ − hₘᵢₙ | area rate | rate | rate | Abnormal | Other |
| | Belt | (60°) | (85°) | μm | (%) | (%) | (% ) | image | abnormality |
| Ex. 1 | A | 4.8 | 56.0 | 0.04 | 63.6 | 94.5 | 93.6 | — | — |
| Ex. 2 | B | 2.3 | 42.2 | 0.09 | 75.9 | 96.8 | 96.2 | — | — |
| Ex. 3 | C | 3.0 | 48.3 | 0.07 | 81.1 | 97.2 | 96.8 | — | — |
| Ex. 4 | D | 0.5 | 36.6 | 0.16 | 68.5 | 93.7 | 93.0 | — | — |
| Ex. 5 | E | 1.9 | 40.9 | 0.10 | 73.2 | 92.1 | 90.7 | — | — |
| Ex. 6 | F | 2.4 | 42.1 | 0.08 | 74.4 | 95.9 | 95.4 | — | — |
| Ex. 7 | G | 2.6 | 44.4 | 0.06 | 76.3 | 97.0 | 96.3 | — | — |
| Ex. 8 | H | 3.0 | 45.9 | 0.05 | 75.2 | 96.6 | 95.8 | — | — |
| Comp. | I | 34.4 | 41.7 | — | — | 25.4 | 20.7 | There were | There was |
| Ex. 1 | | | | | | | | white spots | fixation of |
| | | | | | | | | on the most | toner on the |
| | | | | | | | | part | whole area |
| Comp. | J | 0.4 | 7.9 | 2.40 | 78.0 | 97.7 | 75.6 | There was a | Some |
| Ex. 2 | | | | | | | | streaky | particles |
| | | | | | | | | abnormal | were |
| | | | | | | | | image in | exfoliated |
| | | | | | | | | some parts | and |
| | | | | | | | | | cleaning |
| | | | | | | | | | failures |
| | | | | | | | | | were |
| | | | | | | | | | observed |
| Comp. | K | 14.0 | 19.4 | 0.03 | 40.3 | 56.5 | 49.9 | Uneven | There was |
| Ex. 3 | | | | | | | | image | fixation of |
| | | | | | | | | density was | toner in |
| | | | | | | | | observed | some parts |
| | | | | | | | | and there | and |
| | | | | | | | | were white | cleaning |
| | | | | | | | | spots | failures |
| | | | | | | | | | were |
| | | | | | | | | | observed |
| Comp. | L | 0.3 | 31.9 | 0.55 | 79.8 | 96.9 | 77.0 | There was a | Some |
| Ex. 4 | | | | | | | | streaky | particles |
| | | | | | | | | abnormal | were |
| | | | | | | | | image in | exfoliated |
| | | | | | | | | some parts | and |
| | | | | | | | | | cleaning |
| | | | | | | | | | failures |
| | | | | | | | | | were |
| | | | | | | | | | observed |

Examples 1 to 8 exhibited an excellent performance at initial and after printing of image onto 10,000 sheets of paper.

The structure of Example 3 had the highest particle area rate (%) among the Examples of the present invention and a high glossiness at 85°. It is believed that these properties allowed the structure of Example 3 to show the most excellent transfer rate among the Examples of the present invention.

The structures of Examples 2, 6, 7, and 8 had similar transfer rates, which may be resulted from using the same condition other than the pushing force when the spherical resin particles were pushed against the elastic layer. The degrees of transfer rates for these Examples correspond to the order of the particle area rate (%) and glossiness at 85°.

The structure of Example 6 had a relatively low transfer rate in spite of a high glossiness at 85°, which may be due to the lowest particle area rate (%) among the Examples of the present invention.

The structure of Example 4 had a relatively low transfer rate, which may be due to the largest hₘₐₓ−hₘᵢₙ and the lowest glossiness at 85° among the Examples of the present invention, and the relatively low particle area rate (%).

The structure of Example 5 had a relatively low transfer rate, which may be due to the relatively low particle area rate (%) and glossiness at 85°, and the use of acrylic resin particles having inferior toner transferability to silicone resin particles.

While, the structure of Comparative Example 1 had a relatively high glossiness at 60° and at 85°, because the particle layer was not formed and thus there was no concavo-convex pattern in the surface of the elastic layer. This structure, however, had a significantly low transfer rate at initial and after printing of image onto 10,000 sheets of paper, because the surface of the elastic layer was tacky due to the absence of particles.

The structure of Comparative Example 2 had a low Glossiness at 60° and at 85°, because the mixture of two types of particles having greatly different particle sizes resulted in large protrusions and large depressions. This structure showed an excellent transfer performance at initial, but after printing of image onto 10,000 sheets of paper, the contaminants such as small toner particles and paper powders had attached to the gaps between the particles, causing a cleaning failure. Additionally, some particles were exfoliated. These are believed to be reasons of the low durability.

In the structure of Comparative Example 3, the elastic layer was not entirely coated with particles since the sufficient amount of particles were not supplied. Thus, various failures occurred such as cleaning failure and fixation of toner to the exposed area of the elastic body.

The structure of Comparative Example 4 had a low glossiness at both 60° and 85°, because the mixture of two types of particles having greatly different particle sizes resulted in large protrusions and large depressions. This structure showed an excellent transfer performance at the initial state, but after printing of image onto 10,000 sheets of paper, the contaminants such as small toner particles and paper powders were attached to the gaps between the particles (filming), causing a cleaning failure. Additionally, some particles were exfoliated. These are believed to be reasons of the low durability.

As described above, the present invention makes it possible to obtain an intermediate transfer belt which is capable of realizing a high transfer rate regardless of the type of a transfer medium, superior in residual toner cleaning property and filming resistance, and capable of being used to realize an electrophotographic apparatus which has high durability and can form high-quality images over a long period of time.

The aspects of the present invention include the aspects as follows.

<1> An intermediate transfer belt configured to receive a toner image formed by developing, with a toner, a latent image on an image bearing member, the intermediate transfer belt including:

a base layer; and

an elastic layer laid on the base layer;

wherein the elastic layer includes spherical resin particles and a layer formed of an elastic body, and has a concavo-convex pattern in a surface of the elastic layer,

wherein the spherical resin particles are arranged in a plane direction in the surface of the elastic layer, and

wherein the intermediate transfer belt has glossiness of 35% or higher as determined based on reflected light at 85° on the surface of the intermediate transfer belt.

<2> The intermediate transfer belt according to <1>, wherein the intermediate transfer belt has glossiness of 5% or lower as determined based on reflected light at 60° on the surface of the intermediate transfer belt.

<3> The intermediate transfer belt according to <1> or <2>, wherein when h denotes an exposed height which is the height of an exposed portion of each of the spherical resin particles from the surface of the layer formed of the elastic body, the elastic layer satisfies the expression hₘₐₓ−hₘᵢₙ≦0.2 μm where hₘₐₓ denotes the maximum exposed height and hₘᵢₙ denotes the minimum exposed height.

<4> The intermediate transfer belt according to any one of <1> to <3>, wherein a projected area rate of the exposed portions of the spherical resin particles on the surface of the elastic layer is 60% or higher.

<5> The intermediate transfer belt according to any one of <1> to <4>, wherein the spherical resin particles are silicone resin particles.

<6> The intermediate transfer belt according to any one of <1> to <5>, wherein the spherical resin particles are monodisperse particles having a volume average particle diameter of 0.5 μm to 5.0 μm.

<7> The intermediate transfer belt according to any one of <1> to <6>, wherein the elastic body is rubber.

<8>]The intermediate transfer belt according to any one of <1> to <7>, wherein the elastic body is cross-linked rubber.

<9> The intermediate transfer belt according to any one of <1> to <8>, wherein the elastic body is cross-linked acrylic rubber.

<10> An image forming apparatus including: the intermediate transfer belt according to any one of <1> to <9>.

<11> A method for producing the intermediate transfer belt according to any one of <1> to <9> including: forming a base layer;

forming a layer formed of a elastic body over the base layer;

uniformly applying spherical resin particles over the layer formed of the elastic body; and

arranging and burying the spherical resin particles in the layer 2 0 formed of the elastic body and uniformly leveling the spherical resin particles.

This application claims priority to Japanese application No. 2011-024938, filed on Feb. 8, 2011, and incorporated herein by reference.

What is claimed is:

1. An intermediate transfer belt configured to receive a toner image formed by developing, with a toner, a latent image on an image bearing member, the intermediate transfer belt comprising:
a base layer; and
an elastic layer laid on the base layer,
wherein the elastic layer comprises spherical resin particles and a layer formed of an elastic body, and has a concavo-convex pattern in a surface of the elastic layer,
wherein the spherical resin particles are arranged in a plane direction in the surface of the elastic layer, and
wherein the intermediate transfer belt has glossiness of 35% or higher as determined based on reflected light at 85° on the surface of the intermediate transfer belt.

2. The intermediate transfer belt according to claim 1, wherein the intermediate transfer belt has glossiness of 5% or lower as determined based on reflected light at 60° on the surface of the intermediate transfer belt.

3. The intermediate transfer belt according to claim 1, wherein when h denotes an exposed height which is the height of an exposed portion of each of the spherical resin particles from the surface of the layer formed of the elastic body, the elastic layer satisfies the expression hₘₐₓ−hₘᵢₙ≦0.2 μm where hₘₐₓ denotes the maximum exposed height and hₘᵢₙ denotes the minimum exposed height.

4. The intermediate transfer belt according to claim 1, wherein a projected area rate of the exposed portions of the spherical resin particles on the surface of the elastic layer is 60% or higher.

5. The intermediate transfer belt according to claim 1, wherein the spherical resin particles are silicone resin particles.

6. The intermediate transfer belt according to claim 1, wherein the spherical resin particles are monodisperse particles having a volume average particle diameter of 0.5 μm to 5.0 μm.

7. The intermediate transfer belt according to claim 1, wherein the elastic body is rubber.

8. The intermediate transfer belt according to claim 1, wherein the elastic body is cross-linked rubber.

9. The intermediate transfer belt according to claim 1, wherein the elastic body is cross-linked acrylic rubber.

10. An image forming apparatus comprising:
an intermediate transfer belt configured to receive a toner image formed by developing, with a toner, a latent image on an image bearing member,
wherein the intermediate transfer belt comprises a base layer and an elastic layer laid on the base layer;
wherein the elastic layer comprises spherical resin particles and a layer formed of an elastic body, and has a concavo-convex pattern in a surface of the elastic layer,
wherein the spherical resin particles are arranged in a plane direction in the surface of the elastic layer, and
wherein the intermediate transfer belt has glossiness of 35% or higher as determined based on reflected light at 85° on the surface of the intermediate transfer belt.

11. A method for producing an intermediate transfer belt, the method comprising:
forming a base layer;
forming a layer formed of a elastic body over the base layer;
uniformly applying spherical resin particles over the layer formed of the elastic body; and
arranging and burying the spherical resin particles in the layer formed of the elastic body and uniformly leveling the spherical resin particles,
wherein the intermediate transfer belt is configured to receive a toner image formed by developing, with a toner, a latent image on an image bearing member,
wherein the intermediate transfer belt comprises the base layer and an elastic layer laid on the base layer,
wherein the elastic layer comprises the spherical resin particles and the layer formed of the elastic body, and has a concavo-convex pattern in a surface of the elastic layer,
wherein the spherical resin particles are arranged in a plane direction in the surface of the elastic layer, and
wherein the intermediate transfer belt has glossiness of 35% or higher as determined based on reflected light at 85° on the surface of the intermediate transfer belt.
